(19) United States
(12) Patent Application Publication
(10) Pub. No.: US 2025/0153226 A1
(43) Pub. Date: May 15, 2025

(54) WASHING MACHINE, METHOD FOR OPERATING THE SAME, AND INDUSTRIAL PRODUCTION LINE COMPRISING THE SAME

(71) Applicant: RIDEL SAS, Neufchâtel-en-Bray (FR)

(72) Inventor: Philippe RIDEL, Neufchâtel-en-Bray (FR)

(21) Appl. No.: 18/948,045

(22) Filed: Nov. 14, 2024

(30) Foreign Application Priority Data
Nov. 15, 2023 (FR) 2312504

(51) Int. Cl. B08B 3/10; B08B 3/02; B08B 13/00; F25B 30/02

(52) U.S. Cl. CPC B08B 3/10; B08B 3/02; B08B 13/00; F25B 30/02; B08B 2203/007; B08B 2203/027

(57) ABSTRACT

A washing machine comprising a wash chamber, a wash solution tank, a spray bar, a pump, and a recovery tray; wherein the washing machine further comprises a heating pipe, a heat pump configured to heat the wash solution, the heat pump being configured to recover heat from air heated in the wash chamber and to transmit heat to the wash solution circulating in the heating pipe, and a control device configured to control the pump and the heat pump.

The present invention relates to the technical field of washing machines, and more particularly to a washing machine, a method for operating the same, and an industrial production line comprising the same.

The prior art already includes washing machines configured to receive a part to be washed, to spray a detergent liquid onto the part in order to wash it, and then to spray air onto the washed part to dry it. European patent EP3718652 B1, for example, discloses such a washing machine.

Furthermore, in existing washing machines, it is common practice to heat the detergent liquid before spraying it onto the part to be washed, for example to improve washing efficiency or speed up drying. The conventional solution for heating the detergent liquid is to use an electric resistance arranged in the detergent liquid storage tank. However, this heating solution presents a number of drawbacks. In particular, it requires a large amount of energy.

Consequently, prior art solutions proposed for washing machines still present drawbacks, and improvements are possible.

The present invention aims, in particular, to solve the problems indicated above by proposing a washing machine comprising a heat pump, a method for operating the same, and an industrial production line comprising the same.

Thus, the present invention has as its object a washing machine comprising: a wash chamber, configured to receive a part to be washed; a wash solution tank, configured to contain a wash solution; a spray bar, arranged in the wash chamber and configured to spray wash solution onto the part to be washed; a pump configured to pump wash solution in the wash solution tank and send said wash solution to the spray bar; and a recovery tray located, in use, in a lower part of the wash chamber, the recovery tray being configured to recover the wash solution having been sprayed by the spray bar and comprising a fluid outlet fluidly connected to an upper part of the wash solution tank; wherein the washing machine further comprises: a heating pipe configured to be supplied with wash solution by the pump and arranged to return said wash solution to the wash solution tank; a heat pump configured to heat the wash solution, the heat pump comprising a heat transfer fluid circulation loop on which are arranged an evaporator and a condenser, the evaporator being configured to recover the heat coming from the air heated in the wash chamber and to transfer the recovered heat to the heat transfer fluid of the heat transfer fluid circulation loop, and the condenser being configured to transfer heat from the heat transfer fluid of the heat transfer fluid circulation loop to the wash solution circulating in the heating pipe, to heat said wash solution; and a control device configured to control the pump and the heat pump.

For the purposes of the invention, “air” is taken to mean air possibly containing wash solution vapor, the wash solution vapor containing available latent heat. It will be understood that a machine according to the invention is configured to recover heat from the air, including latent heat coming from the wash solution vapor.

This configuration allows, In particular, to obtain a washing machine providing efficient heating of the wash solution by using the heat pump to heat the wash solution during operation but also as early as the washing machine start-up phase. Alternatively, a washing machine according to the invention can be configured to simultaneously receive several parts to be washed in the wash chamber. It will also be understood that the suction of the wash solution by the pump for sending into the heating pipe then sending back into the wash solution tank allows the wash solution in the wash solution tank to be put into circulation, which in particular, allows rapid homogenization of the temperature of the wash solution in the wash solution tank.

The control device may be, in particular, an electronic device, for example a processor, microprocessor, microcontroller, digital signal processor (DSP), field-programmable gate array (FPGA), application-specific integrated circuit (ASIC), comprising or associated with memory which contains instructions for controlling the washing machine. The control device may also include inputs/outputs or even wireless or wired communication devices.

According to one particular embodiment, the washing machine further comprises an additional heat transfer fluid circulation loop, a heat exchanger and at least one from among, a duct configured to fluidly connect the heat exchanger to an interior of the wash chamber, and a free volume arranged in the wash solution tank, above the wash solution, configured to receive air from the wash chamber, the heat exchanger is configured to draw air from at least one from among said duct and said free volume, to recover heat from said drawn air and to transfer the recovered heat to the heat transfer fluid of the additional heat transfer fluid circulation loop, the additional heat transfer fluid circulation loop being arranged, at the heat pump, to transfer the heat from the heat transfer fluid of the additional heat transfer fluid circulation loop to the evaporator of the heat pump.

This configuration allows indirect heat recovery coming from air heated in the wash chamber, by the intermediary of the heat exchanger and the additional heat transfer fluid circulation loop. In particular, this configuration allows the use of a water-to-water type heat pump.

According to one particular embodiment, the washing machine further comprises at least one from among, a duct configured to fluidly connect the heat pump evaporator to an interior of the wash chamber, and a free volume arranged in the wash solution tank, above the wash solution, configured to receive air coming from the wash chamber, and the heat pump is an air to water type heat pump and comprises a first fan configured to draw air from at least one from among said duct and said free volume, and to circulate said drawn air into contact with the evaporator to recover heat from said drawn air.

This configuration allows direct heat recovery coming from air heated in the wash chamber by means of the air to water heat pump and is notably simple in structure.

According to one particular embodiment, the heat pump and, where applicable, the heat exchanger, further comprise a drainage duct configured to recover wash solution vapor contained in the drawn air and condensing at the evaporator when the drawn air passes in contact with the evaporator, if applicable at the heat exchanger when the drawn air passes in contact with the heat exchanger and discharges the recovered condensed vapor to the wash solution tank.

This configuration allows wash solution to be recovered and thus to reduce the wash solution consumption by the washing machine.

According to one particular embodiment, the first fan, and if applicable the heat exchanger, is further configured to selectively draw in air from an immediate environment of the washing machine, in such a manner as to recover heat from said drawn in air.

In the present application, immediate environment is intended to mean the room where the washing machine is installed.

In particular, this configuration allows to selectively draw in air coming from the wash chamber or air coming from the immediate environment of the washing machine, or to mix air coming from the wash chamber and air coming from the immediate environment of the washing machine, for example to control the temperature of said air mixture. It will also be understood that this configuration allows a large quantity of air to be drawn in easily and quickly, which is advantageous for heating the wash solution with the heat pump during a start-up phase, in other words, a phase in which the heat pump is used to heat the wash solution from an ambient temperature, for example, 20° C., up to an operating temperature, for example, 60° C. It will also be understood that, alternatively, the washing machine can be configured to open the wash chamber during the start-up phase, in such a manner as to allow air to be drawn from the immediate environment of the washing machine through the wash chamber, or that the wash chamber can comprise a valve configured to open automatically when pressure drops in the wash chamber, in such a manner as to let air in from the immediate environment of the washing machine.

According to one particular embodiment, the washing machine further comprises a mesh filter, acting as a droplet separator, arranged upstream of the evaporator, possibly upstream of the heat exchanger, the mesh filter being further configured to linearize the flow of drawn air passing through it.

It will be understood that this technical solution allows wash solution to be recovered and therefore to reduce the consumption of wash solution of the washing machine, but also to reduce the quantity of vapor contained in the drawn air, released into the immediate environment of the washing machine.

According to one particular embodiment, the washing machine comprises a buffer tank, acting as an expansion tank, arranged upstream of the mesh filter and configured to recover the droplets of wash solution and linearize the flow of drawn air passing through it.

It will be understood that this technical solution allows wash solution to be recovered, and therefore to reduce the consumption of wash solution by the washing machine, but also to reduce the quantity of vapor, contained in the drawn air, released into the immediate environment of the washing machine.

According to one particular embodiment, the recovery tray is movable, and the washing machine further comprises a mechanical system configured to displace the recovery tray vertically so as to open and close the wash chamber hermetically.

It will be understood that this configuration makes it easy to load and unload one or more parts into the wash chamber.

According to one particular embodiment, to ensure degraded operation, the wash solution tank comprises an auxiliary heating means of the washing solution, preferably an electric resistance.

Preferably, the auxiliary heating means is provided to improve the operating reliability of the washing machine but is not intended to be used. Alternatively, the washing machine can use the auxiliary heating means, in combination with or instead of the heat pump, to heat the wash solution during a machine start-up phase.

According to a particular embodiment, the washing machine further comprises a wash solution supply control valve arranged between the pump and the spray bar, and a supply system for blowing fluid, fluidly connected to the spray bar by means of a blowing fluid supply control valve, the spray bar being further configured to alternately spray the wash solution and the blowing fluid by being alternately connected to the wash solution tank and the blowing fluid supply system, and the control device being configured to control the supply control valves to control the supply of wash solution and blowing fluid to the spray bar.

It will be understood that a washing machine according to this embodiment is, preferably, configured to allow drying of the part by spraying blowing fluid through the spray bar.

According to one particular embodiment, the heat pump further comprises an air condenser arranged on the heat transfer fluid circulation loop, between the condenser and the evaporator and upstream of an expansion valve of the heat transfer fluid circulation loop, and a second fan configured to draw in at least one from among the air exiting the evaporator and air coming from an immediate environment of the washing machine and to circulate said drawn air in contact with the air condenser.

It will be understood that the air condenser allows the heat transfer fluid in the heat transfer fluid circulation loop to be cooled. Therefore, it will be understood that, if the temperature of the wash solution is too high, the second fan can be controlled by the control device to limit heating of the wash solution by the heat pump.

The present invention also has as its object a method of operating a machine according to the invention, wherein the method comprises steps consisting of:
a) operating the pump to circulate the wash solution in the heating pipe, operating the first fan of the heat pump at a first speed to draw air from an immediate environment of the washing machine and circulate said air in contact with the evaporator, measuring a temperature of the wash solution using a temperature sensor in the wash solution tank, and operating the heat pump to heat the wash solution to a first target temperature, in such a manner as to start-up the washing machine;
b) operating the pump to supply the wash solution to the spray bar and to circulate wash solution through the heating pipe, operating the heat pump to heat the wash solution, operating the first fan at a second speed, less than or equal to the first speed, to draw air from the immediate environment of the washing machine and circulate said air in contact with the evaporator, and operating the second fan to draw both air from the evaporator and air from the immediate environment of the washing machine and circulate said air in contact with the air condenser;
c) operating the pump to circulate the wash solution in the heating pipe, stopping the supply of wash solution to the spray bar, operating the blowing fluid supply system to supply the blowing fluid to the spray bar, operating the heat pump to heat the wash solution, operating the first fan at the second speed to draw in air from the wash chamber and circulate said air in contact with the evaporator, and operating the second fan to draw in both air exiting the evaporator and air coming from the immediate environment of the washing machine and circulate said air in contact with the air condenser;
d) measuring the temperature of the wash solution using the temperature sensor in the wash solution tank; and
e) if the temperature of the wash solution is higher than a second target temperature, increasing an operating speed of the second fan, the second target temperature being greater than or equal to the first target temperature.

It will be understood that the control device is configured to control the washing machine in such a manner as to execute the method. It will also be understood that step
a) corresponds to a step for starting up the washing machine,
b) corresponds to a step for washing a part,
c) corresponds to a step for drying the part, and
d) and e) correspond to temperature monitoring and adjustment steps.

It will therefore be understood that, for series operation,
step a) can be performed only once and that a plurality of parts can be successively introduced into the washing machine,
steps b) to e) being performed for each part (possibly each batch of parts) introduced into the washing machine.

It will also be understood that according to a non-preferred alternative, the start-up step can use the auxiliary heating means, in combination with or instead of the heat pump, to heat the wash solution up to the first target temperature.

The present invention also has as its object an industrial production line, wherein the industrial production line comprises at least one washing machine according to the invention configured to sequentially receive, with wash cycles of less than 5 minutes, a plurality of parts to be washed and at least one conveying device configured to convey the plurality of parts to be washed and sequentially introduce the plurality of parts to be washed into the at least one washing machine.

Particular embodiments of the present invention will now be described, with reference to the appended drawings.

In these drawings:

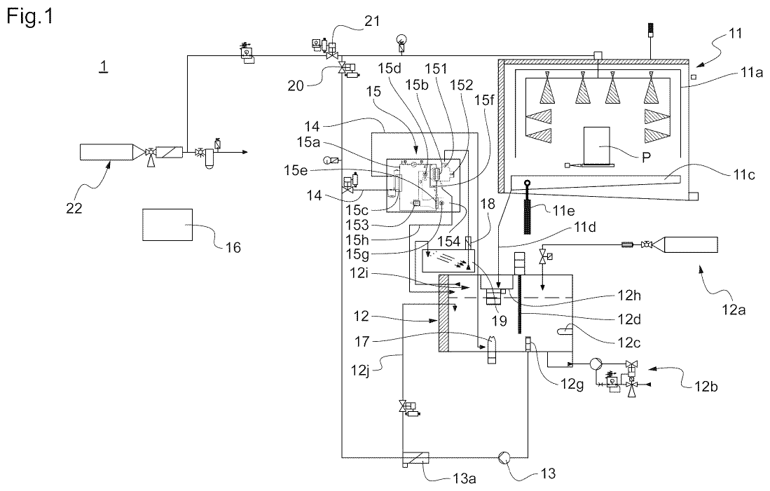

FIG. 1 is a schematic representation of a washing machine according to a first embodiment of the present invention.

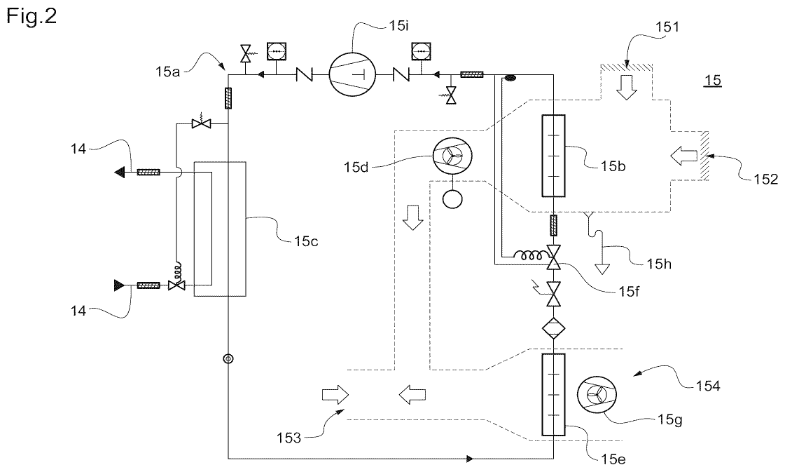

FIG. 2 is an enlarged schematic representation of the heat pump of the washing machine of FIG. 1.

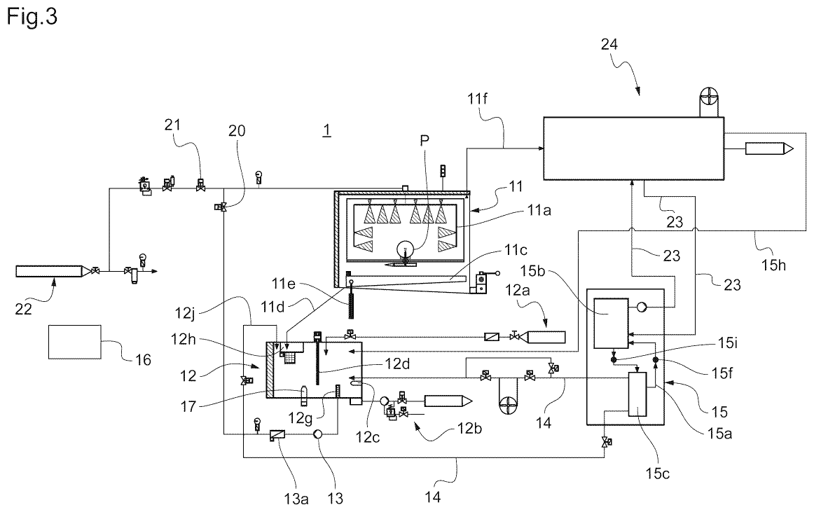

FIG. 3 is a schematic representation of a washing machine according to a second embodiment of the present invention.

Referring, first of all, to FIG. 1, it can be seen that a washing machine 1 according to a first embodiment of the present invention has been represented, comprising a wash chamber 11, a wash solution tank 12, a spray bar 11a, a pump 13, a recovery tray 11c, a heating pipe 14, a heat pump 15, and a control device 16.

The wash chamber 11 is configured to receive a part P to be washed, for example a part P that has just been machined. It will also be understood that as an alternative, a washing machine 1 according to the invention can be configured to simultaneously receive several parts P to be washed in the wash chamber 11.

The wash solution tank 12 is configured to contain a wash solution intended for washing the part P to be washed. The wash solution may, for example, be water, a water-based washing solution or a detergent or oil-based solution. In the case where the part P to be washed is a part P that has just been machined, it will be understood that the washing solution is preferably chosen to allow a lubricating liquid, used during machining of the part P to be washed, to be removed from the surface of the part P.

The washing machine 1 further comprises a wash solution supply source 12a configured to supply washing solution to the wash solution tank 12 and, preferably, a discharge system 12b configured to remove wash solution from the wash solution tank 12. It will be understood that the wash solution supply source 12a and the discharge system 12b are configured to adjust the level of wash solution in the wash solution tank 12, and that the discharge system 12b is further configured to allow, if required, complete emptying of the wash solution tank 12, for example to clean the wash solution tank 12. It will also be understood that the wash solution supply source 12a may, for example, comprise a supply pipe connected to a building water supply pipe, and optionally an additive mixing device configured to add additives to the water to form the wash solution. Alternatively, the wash solution supply source 12a may be an opening configured to supply the wash solution tank 12 from one or more external containers, for example from containers of washing solution or wash solution.

In the embodiment represented in FIG. 1, the wash solution tank 12 comprises a temperature sensor 12c configured to measure a temperature of the wash solution and a liquid level probe 12d configured to measure a level of the wash solution.

The spray bar 11a is arranged in the wash chamber 11 and is configured to spray wash solution onto the part P to be washed.

The pump 13 is fluidly connected to the spray bar 11a and is configured to pump wash solution into the wash solution tank 12 and deliver said wash solution to the spray bar 11a. In the embodiment represented in FIG. 1, the pump 13 is configured to pump the wash solution from a lower part of the wash solution tank 12 through a strainer 12g configured to filter out any impurities present in the wash solution tank 12. According to the embodiment represented in FIG. 1, the washing machine 1 also comprises a filter 13a at the outlet of the pump 13.

The recovery tray 11c is positioned, in use, at a lower part of the wash chamber 11 and is configured to recover the wash solution that has been sprayed by the spray bar 11a. The recovery tray 11c comprises a fluid outlet 11d fluidly connected to an upper part of the wash solution tank 12. According to the embodiment represented in FIG. 1, the upper part of the wash solution tank 12 comprises an inlet filter 12h configured to filter the wash solution and air coming from the wash chamber 11 upon entry into the wash solution tank 12. The inlet filter 12h may, for example, be a swarf basket configured to collect swarf formed during machining of the part P to be washed.

In the embodiment represented in FIG. 1, the recovery tray 11c is movable and the washing machine 1 further comprises a mechanical system 11e, for example, an electric actuator, for example, an electric cylinder, configured to displace the recovery tray 11c vertically in such a manner as to open and close the wash chamber 11 hermetically. It will be understood, however, that alternatively the collection tray 11c could be fixed and the wash chamber 11 could comprise another means for introducing a part P, for example a door formed in a side wall of the wash chamber 11.

The heating pipe 14 is configured to be supplied with wash solution by the pump 13 and is arranged to return said wash solution to the wash solution tank 12, preferably to the lower part of the wash solution tank 12 to promote temperature homogenization in the wash solution tank 12. According to the embodiment represented in FIG. 1, the heating pipe 14 branches off from a pipe connecting the pump 13 to the spray bar 11a, although it is understood that, alternatively, the heating pipe 14 may be a dedicated pipe. It will also be understood that, alternatively, the pump 13 may comprise a first pump unit configured to send the wash solution to the spray bar 11a, and a second pump unit configured to send the wash solution to the heating pipe 14.

Still according to the embodiment represented in FIG. 1, the washing machine 1 further comprises a return pipe 12j configured to directly return wash solution to the wash solution tank 12 when the supply of wash solution to the spray bar 11a is stopped. It will be understood that as an alternative, the washing machine 1 can be without a return line 12j, the excess wash solution then being returned to the wash solution tank 12 by the heating pipe 14.

The heat pump 15 is configured to heat the wash solution used by the washing machine 1 during all phases of use of the washing machine 1. However, it will be understood that, for example, to improve the reliability of use of the washing machine 1, the means of heating the washing machine 1 can be doubled. In particular, the wash solution tank 12 may further comprise an auxiliary heating means 17 for the wash solution, the auxiliary heating means 17 may advantageously be an electric resistance.

Referring also to FIG. 2, it can be seen that the heat pump 15 comprises a heat transfer fluid circulation loop 15a on which an evaporator 15b and a condenser 15c are arranged.

As will be described in more detail below, the evaporator 15b is configured to recover, directly or indirectly, the heat from air heated in the wash chamber 11 and to transfer the recovered heat to the heat transfer fluid of the heat transfer fluid circulation loop 15a, and the condenser 15c is configured to transmit heat from the heat transfer fluid of the heat transfer fluid circulation loop 15a to the wash solution circulating in the heating pipe 14, to heat said wash solution.

For the purposes of this invention, “air” is taken to mean air that may contain wash solution vapor, since wash solution vapor contains available latent heat. It will be understood that a machine 1 according to the invention is configured to recover heat from the air, including latent heat coming from the wash solution vapor.

It will also be understood that the suction of wash solution by the pump 13 for delivery into the heating pipe 14 and then back into the wash solution tank 12 allows circulation of the wash solution in the wash solution tank 12, which in particular, allows rapid homogenization of the temperature of the wash solution in the wash solution tank 12.

The control device 16 is configured to control the pump 13 and the heat pump 15.

The control device 16 may, in particular, be an electronic device, for example a processor, microprocessor, microcontroller, digital signal processor (DSP), field-programmable gate array (FPGA), application-specific integrated circuit (ASIC), comprising or associated with memory that contains instructions for controlling the washing machine 1. The control device 16 may also include inputs/outputs or even wireless or wired communication devices.

In the first embodiment represented in FIGS. 1 and 2, the evaporator 15b is configured to directly recover heat coming from the heated air in the wash chamber 11, while in the second embodiment represented in FIG. 3, the evaporator 15b is configured to indirectly recover heat coming from the heated air in the wash chamber 11.

In the first embodiment represented in FIGS. 1 and 2, the washing machine 1 further comprises a free volume 12i, arranged in the wash solution tank 12 above the wash solution, configured to receive air coming from the wash chamber 11. It will be understood that, in use, air present in the wash chamber 11 passes through the fluid outlet 11d of the recovery tray 11c and arrives in the free volume 12i. Furthermore, the heat pump 15 is an air to water type heat pump 15 and comprises a first fan 15d configured to draw, through a first air inlet 151 of the heat pump 15, the air from the free volume 12i, and to circulate said drawn air into contact with the evaporator 15b to recover heat from said drawn air. It will be understood that, in use, the air heats up in the wash chamber 11, the wash chamber 11 being heated by the wash solution.

It will also be understood that, according to alternatives, the washing machine 1 may comprise, as a replacement for or in addition to the free volume 12i, a duct configured to fluidly connect the evaporator 15b of the heat pump 15 to an interior of the wash chamber 11, by means of the first air inlet 151 of the heat pump 15. It will be understood that the first fan 15d of the heat pump 15 is then configured to draw air from said duct through the first air inlet 151, by replacing or complementing the air drawn from the free volume 12i described above. For example, the said duct could be connected to the wash chamber 11 in a manner similar to the duct 11f of the second embodiment which will be described in greater detail below.

In the embodiment represented in FIG. 1, the first fan 15d is further configured to selectively draw in air from an immediate environment of the washing machine 1, by means of a second air inlet 152, in such a manner as to recover heat from said drawn air. It will be understood that the heat pump 15 may, for example, comprise a valve configured to selectively open and close the second air inlet 152, for example a valve controlled, directly or indirectly, by the control device. It will also be understood that the control device 16 of the washing machine 1 is configured to control the heat pump 15 in such a manner as to draw air selectively from the first air inlet 151 and from the second air inlet 152. It will also be understood that this notably allows air to be drawn in from either of the air inlets 151, 152, or to mix air entering through the first air inlet 151 with air entering through the second air inlet 152, for example to control the temperature of said air mixture. It will also be understood that this configuration allows a large quantity of air to be easily and quickly drawn in through the second air inlet 152, which is advantageous for heating the wash solution with the heat pump 15 during a start-up phase, in other words, a phase during which the heat pump 15 is used to heat the wash solution from an ambient temperature, for example 20° C., to a use temperature, for example 60° C. It will also be understood that, as an alternative, the washing machine 1 can be configured to open the wash chamber 11 during the start-up phase, so as to allow air to be drawn in from the immediate environment of the washing machine 1 through the wash chamber 11, or that the wash chamber 11 can comprise a valve configured to open automatically when a pressure drops in the wash chamber 11, so as to let air in from the immediate environment of the washing machine 1.

Referring to FIG. 2, it can be seen that in the first embodiment, the heat pump 15 further comprises an air condenser 15e arranged on the heat transfer fluid circulation loop 15a, between the condenser 15c and the evaporator 15b and upstream of an expansion valve 15f of the heat transfer fluid circulation loop 15a. It will be understood that the expansion valve 15f is arranged on the heat transfer fluid circulation loop 15a between the condenser 15c and the evaporator 15b, and that the heat pump 15 also comprises a compressor 15i arranged on the heat transfer fluid circulation loop 15a between the evaporator 15b and the condenser 15c. The heat pump 15 further comprises a second fan 15g configured to draw in air exiting the evaporator 15b and air coming from the immediate environment of the washing machine 1, by means of an air inlet/outlet 153, and to circulate said drawn air into contact with the air condenser 15e prior to discharge from the heat pump 15 by means of an air outlet 154. It will be understood that, when the second fan 15g is not operated, the air exiting the evaporator 15b exits through the inlet/outlet 153 of the heat pump 15, due to the pressure losses induced by the air condenser 15e arranged in front of the air outlet 154.

It will also be understood that the air condenser 15e allows the heat transfer fluid in the heat transfer fluid circulation loop to be cooled. It will therefore be understood that if the temperature of the wash solution measured by the temperature sensor 12c is higher than a desired value, the control device 16 is configured to increase the operating speed of the second fan 15g in such a manner as to limit heating of the wash solution by the heat pump 15.

Drawing in both air exiting the evaporator 15b and air coming from the immediate environment of the washing machine 1 using the second fan 15g, allows air that has been cooled on contact with the evaporator 15b to be mixed with air coming from the immediate environment of the washing machine 1, and reheat this mixture by cooling the air condenser 15e, so as not to create a trace of mist at the air outlet 154 of the heat pump 15. It will be understood, however, that according to alternatives, the second fan 15g can be configured to draw in only air exiting the evaporator 15b or only air coming from the immediate environment of the washing machine 1.

In the embodiment represented in FIG. 1, the heat pump 15 further comprises a drainage duct 15h configured to recover wash solution vapor contained in the drawn air and condensing at the evaporator 15b as the drawn air passes in contact with the evaporator 15b, and to discharge the recovered condensed vapor to the wash solution tank 12.

According to the embodiment represented in FIG. 1, the washing machine 1 also comprises a mesh filter 18, acting as a droplet separator, located upstream of the evaporator 15b. The mesh filter 18 is further configured to linearize the flow of the drawn air passing through it. The mesh filter 18 is preferably a plastic mesh filter 18. In addition, the washing machine 1 comprises a buffer tank 19, acting as an expansion tank, arranged upstream of the mesh filter 18 and configured to recover wash solution droplets, in particular by droplet fallout during variations in air speed in the buffer tank 19, and to linearize the flow of suction air passing through it. Preferably, the mesh filter 18 is arranged directly at the outlet of the buffer tank 19. According to the embodiment represented in FIG. 1, the buffer tank 19 has a rectangular block shape with a volume of 1 m³, but could have any other shape, for example, a cylindrical shape, or any other volume. The air drawn in by the first fan 15d of the heat pump 15 is introduced into the buffer tank 19 through an upper surface at a first end, then circulates in the buffer tank 19, and is extracted by suction from the first fan 15d, at a second end of the buffer tank 19, opposite the first end. Preferably, the height at which air is drawn from the buffer tank 19 is lower than the height at which the air is introduced into the buffer tank 19. Even more preferably, the air is drawn into the buffer tank 19 through a tube, the distal end of which forms a bevel, for example 45°, oriented toward the air entry point, in such a manner that the air flowing through the buffer tank 19 is further slowed down between the entry point and the exit point. It is understood that linearization of the drawn air flow means a reduction and homogenization of the drawn air speed, that is, air speed variations at the outlet are less than at the inlet, and a reduction in the quantity of wash solution vapor sucked in.

It will be understood that the buffer tank 19 is configured to be regularly emptied of the wash solution recovered by the mesh filter 18 and the buffer tank 19, for example manually, into the wash solution tank 12. It will also be understood that, as an alternative, the washing machine 1 may further comprise a drainage duct configured to discharge recovered wash solution to the wash solution tank 12, the drainage duct connecting, for example, a bottom of the buffer tank 19 to the upper part of the wash solution tank 12.

According to a non-preferred alternative, the mesh filter 18 can be used in combination with the free volume 12i. According to this alternative, the mesh filter 18 is placed directly at the outlet of the wash solution tank 12, so that the free volume 12i acts as a buffer tank.

It will be understood that the technical solutions indicated above allow the wash solution to be recovered and therefore reduce the wash solution consumption of the washing machine 1, but also to reduce a quantity of vapor, contained in the drawn air, released in the immediate environment of the washing machine 1. It will also be understood that the reduction in wash solution consumption also allows the energy consumption of the washing machine 1 to be reduced, since the quantity evaporated is less, which allows the amount of heat required for evaporation to be reduced.

It will be understood that, preferably, the evaporator 15b of the heat pump 15, the mesh filter 18 and the buffer tank 19 are configured and dimensioned in such a way that all the wash solution vapor contained in the air drawn into the heat pump 15 is condensed and recovered, in such a way that the air having been drawn into the heat pump 15 can be released into the immediate environment of the washing machine 1 without loading the air in the immediate environment of the washing machine 1 with wash solution vapor. In the case where the wash solution is a washing solution or a detergent solution, the air outlet 154 and the air inlet/outlet 153 of the heat pump 15 may comprise filters configured to trap any harmful airborne compounds coming from the wash solution before releasing the air into the immediate environment of the washing machine 1.

In the embodiment represented in FIG. 1, the washing machine 1 is further configured to allow drying of the part P. In particular, the washing machine 1 further comprises a wash solution supply control valve 20 arranged between the pump 13 and the spray bar 11a, and a blowing fluid supply system 22 fluidly connected to the spray bar 11a by means of a blowing fluid supply control valve 21. The spray bar 11a is further configured to alternately spray wash solution and blowing fluid by being alternately connected to the wash solution tank 12 and the blowing fluid supply system 22, and the control device 16 is configured to control the supply control valves 20, 21 to control the supply of wash solution and blowing fluid to the spray bar 11a. The blowing fluid may, for example, be air and the blowing fluid supply system 22 may, for example, be a compressed air supply system or a pulsed compressed air supply system. It will be understood that, when supplying blowing fluid to the spray bar 11a, variable blowing fluid pressures can be used. Alternatively, the spray bar 11a may be supplied with blowing air by a fan, or the washing machine 1 may additionally comprise a second blowing bar supplied with blowing air by a fan.

A method for operating a washing machine 1 according to the embodiment represented in FIG. 1 will now be briefly described.

The method comprises a step a) consisting of operating the pump 13 to circulate wash solution in the heating pipe 14, operating the first fan 15d of the heat pump 15 at a first speed (for example, 60 Hz) to draw air from the immediate environment of the washing machine 1 and circulate said air in contact with the evaporator 15b, measuring a temperature of the wash solution using the temperature sensor 12c in the wash solution tank 12, and operating the heat pump 15 to heat the wash solution to a first target temperature (for example, a temperature of between 55 and 60° C.), in such a manner as to start-up the washing machine 1.

The method then comprises a step b) consisting of operating the pump 13 to supply the spray bar 11a with wash solution and to circulate wash solution through the heating pipe 14, operating the heat pump 15 to heat the wash solution, operating the first fan 15d at a second speed (for example, 30 Hz or 60 Hz), lower than or equal to the first speed, to draw air from the immediate environment of the washing machine 1 and circulate said air in contact with the evaporator 15b, and operating the second fan 15g (for example at 30 Hz) to draw both air exiting the evaporator 15b and air coming from the immediate environment of the washing machine 1 and circulating said air in contact with the air condenser 15e.

The method then comprises a step c) consisting of operating the pump 13 to circulate the wash solution in the heating pipe 14, stopping the supply of wash solution to the spray bar 11a, operating the blowing fluid supply system 22 to supply blowing fluid to the spray bar 11a, operating the heat pump 15 to heat the wash solution, operating the first fan 15d at the second speed (for example, 30 Hz or 60 Hz) to draw air from the wash chamber 11 and circulate said air in contact with the evaporator 15b, and operating the second fan 15g (for example, at 30 Hz) to draw both air exiting the evaporator 15b and air coming from the immediate environment of the washing machine 1 and circulate said air in contact with the air condenser 15e.

The method then comprises a step d) consisting in measuring the temperature of the wash solution using the temperature sensor 12c in the wash solution tank 12.

The method then comprises a step e) consisting, if the temperature of the wash solution is higher than a second target temperature (for example, between 6° and 65° C.), in increasing an operating speed of the second fan (for example, to 60 Hz), the second target temperature being greater than or equal to the first target temperature.

It will be understood that the control device 16 is configured to control the washing machine 1 in such a manner as to execute the method.

It will also be understood that:
step a) corresponds to a step for starting up the washing machine 1, that;
step b) corresponds to a step for washing a part P, that;
step c) corresponds to a step for drying the part P, and that
steps d) and e) correspond to temperature monitoring and adjustment steps.

It will therefore be understood that, for series operation:
step a) can be carried out only once and that a plurality of parts (possibly a plurality of batches of parts) can be successively introduced into the washing machine,
steps b) to e) being carried out for each part P (if necessary, each batch of parts) introduced into the washing machine 1. It will also be understood that, according to a non-preferred alternative, the start-up step may use the auxiliary heating means 17, in combination with or in place of the heat pump 15, to heat the wash solution up to the first target temperature.

Referring now to FIG. 3, it can be seen that a washing machine 1 according to a second embodiment of the invention has been represented, the elements having the same function as in the first embodiment being indicated by the same reference number.

The second embodiment differs from the first embodiment only in that, in the second embodiment, the evaporator 15b is configured to indirectly recover heat coming from air heated in the wash chamber 11.

To this end, the washing machine 1 comprises an additional heat transfer fluid circulation loop 23, a heat exchanger 24 and a duct 11f configured to fluidly connect the heat exchanger 24 to the interior of the wash chamber 11. The duct 11f is preferably connected to an upper part of the wash chamber 11.

The heat exchanger 24 is configured to draw air from the duct 11f, to recover heat from said drawn air and to transfer the recovered heat to the heat transfer fluid of the additional heat transfer fluid circulation loop 23. Furthermore, the additional heat transfer fluid circulation loop 23 is arranged, at the heat pump 15, to transfer heat from the heat transfer fluid of the additional heat transfer fluid circulation loop 23 to the evaporator 15b of the heat pump 15.

Furthermore, it will be understood that, according to alternatives of the second embodiment, the washing machine 1 may comprise, as a replacement for or in addition to the duct 11f, a free volume arranged in the wash solution tank 12, above the wash solution, configured to receive air coming from the wash chamber 11. It will be understood that the heat exchanger 24 is then configured to draw air from said free volume, by replacing or complementing the air drawn from the duct 11f described above. For example, the said free volume could be arranged in the wash solution tank 12 in a manner similar to the free volume 12i of the first embodiment described above.

It will also be understood that, in the second embodiment, it is the heat exchanger 24 which comprises the drainage duct 15h configured to recover wash solution vapor contained in the drawn air and condensing at the heat exchanger 24 and discharge the recovered condensed vapor toward the wash solution tank 12.

It will also be understood that, preferably in a similar manner to what has been described for the first embodiment, in the second embodiment, the heat exchanger 24 is configured to selectively draw in air from the immediate environment of the washing machine 1, in such a manner as to recover heat from said drawn air. It will also be understood that the washing machine 1 may comprise a mesh filter 18, acting as a droplet separator, arranged upstream of the heat exchanger 24, the mesh filter 18 being further configured to linearize the flow of the drawn air passing through it, and the washing machine 1 may comprise a buffer tank 19, acting as an expansion tank, arranged upstream of the mesh filter 18 and configured to recover wash solution droplets and linearize the flow of the drawn air passing through it.

It will be understood that in this case, the heat exchanger 24, the mesh filter 18 and the buffer tank 19 are preferably configured and dimensioned in such a way that all the wash solution vapor contained in the air drawn into the heat exchanger 24 is condensed and recovered, in such a way that the air that has been drawn into the heat exchanger 24 can be released into the immediate environment of the washing machine 1 without loading the air in the immediate environment of the washing machine 1 with wash solution vapor. It will also be understood that in the case where the wash solution is a washing solution or a detergent solution, the air outlet of the heat exchanger 24 may comprise filters configured to trap any harmful airborne compounds coming from the wash solution before discharging the air into the immediate environment of the washing machine 1.

The invention also relates to an industrial production line comprising one or more washing machines 1 according to the invention, configured to sequentially receive, with washing cycles of less than 5 minutes, a plurality of parts P to be washed and one or more conveying devices configured to convey the plurality of parts P to be washed and sequentially introduce the plurality of parts P to be washed into the washing machine(s) 1. A conveying device may, for example, comprise a conveyor belt, a rotary table, or a robotic arm.

It will be understood that a washing machine 1 according to the invention may, for example, be a washing machine configured to wash parts P coming out of machining, or any other washing machine 1 using a heated wash solution. A washing machine 1 according to the invention is also particularly suitable for washing cycles of between 3 and 5 minutes.

It is understood that the particular embodiments just described are indicative and non-limiting, and that modifications may be made without departing from the scope of the present invention.

1- A washing machine comprising:
a wash chamber, configured to receive a part to be washed;
a wash solution tank, configured to contain a wash solution;
a spray bar, arranged in the wash chamber and configured to spray wash solution onto the part to be washed;
a pump configured to pump wash solution in the wash solution tank and send the wash solution to the spray bar; and
a recovery tray located, in use, at a lower part of the wash chamber, the recovery tray being configured to recover wash solution having been sprayed by the spray bar and comprising a fluid outlet fluidly connected to an upper part of the wash solution tank;
a heating pipe configured to be supplied with wash solution by the pump and arranged to return the wash solution to the wash solution tank;
a heat pump configured to heat the wash solution, the heat pump comprising a heat transfer fluid circulation loop on which are arranged an evaporator and a condenser, the evaporator being configured to recover heat coming from the air heated in the wash chamber and to transfer the recovered heat to the heat transfer fluid of the heat transfer fluid circulation loop, and the condenser being configured to transfer heat from the heat transfer fluid of the heat transfer fluid circulation loop to the wash solution circulating in the heating pipe, to heat the wash solution; and
a control device configured to control the pump and the heat pump,
wherein the washing machine further comprises one from among:
a first fan configured to selectively draw air from an immediate environment of the washing machine and to circulate the drawn air into contact with the evaporator to recover heat from the drawn air, the heat pump being an air to water type heat pump and comprising the first fan; and
a heat exchanger configured to selectively draw air from an immediate environment of the washing machine to recover heat from the drawn air and to transfer recovered heat to a heat transfer fluid of an additional heat transfer fluid circulation loop of the washing machine, the additional heat transfer fluid circulation loop being arranged, at the heat pump, to transfer heat from the heat transfer fluid of the additional heat transfer fluid circulation loop to the evaporator of the heat pump.

2- The washing machine according to claim 1 when it comprises the additional heat transfer fluid circulation loop and the heat exchanger, wherein:
the washing machine further comprises at least one from among a duct configured to fluidly connect the heat exchanger to an interior of the wash chamber, and a free volume arranged in the wash solution tank, above the wash solution, configured to receive air coming from the wash chamber; and
the heat exchanger is further configured to draw air from among at least one of the duct and the free volume, to recover heat from the drawn air and to transfer the recovered heat to the heat transfer fluid of the additional heat transfer fluid circulation loop.

3- The washing machine according to claim 1 when the heat pump is of the air to water type and comprises the first fan, wherein:
the washing machine further comprises at least one from among a duct configured to fluidly connect the evaporator of the heat pump to an interior of the wash chamber, and a free volume arranged in the wash solution tank, above the wash solution, configured to receive air from the wash chamber; and
the first fan is further configured to draw air from at least one from among the duct and the free volume, and to circulate the drawn air into contact with the evaporator to recover heat from the drawn air.

4- The washing machine according to claim 2, wherein the heat pump, and when present the heat exchanger, further comprises a drainage pipe configured to recover the wash solution vapor contained in the drawn air and condensing at the evaporator when the drawn air passes in contact with the evaporator, when present at the heat exchanger as the drawn air passes over the heat exchanger, and discharge the recovered condensed vapor to the wash solution tank.

5- The washing machine according to claim 2, wherein the washing machine further comprises a mesh filter, acting as a droplet separator, arranged upstream of the evaporator, upstream of the heat exchanger when present, the mesh filter being further configured to linearize the flow of the drawn air passing through it.

6- The washing machine according to claim 5, wherein the washing machine comprises a buffer tank, acting as an expansion tank, arranged upstream of the mesh filter and configured to recover droplets of wash solution and linearize the flow of the drawn air passing through it.

7- The washing machine according to claim 1, wherein the recovery tray is movable and the washing machine further comprises a mechanical system configured to vertically displace the recovery tray in such a manner as to open and close the wash chamber hermetically.

8- The washing machine according to claim 1, wherein, to ensure degraded operation, the wash solution tank comprises auxiliary wash solution heating means, preferably an electric resistance.

9- The washing machine according to claim 1, wherein the washing machine further comprises a wash solution supply control valve arranged between the pump and the spray bar, and a blowing fluid supply system fluidly connected to the spray bar by means of a blowing fluid supply control valve, the spray bar being further configured to alternately spray wash solution and blowing fluid by being alternately connected to the wash solution tank and the blowing fluid supply system, and the control device being configured to control the supply control valves to control the supply of wash solution and blowing fluid to the spray bar.

10- The washing machine according to claim 3, wherein the washing machine further comprises a wash solution supply control valve arranged between the pump and the spray bar, and a blowing fluid supply system fluidly connected to the spray bar by means of a blowing fluid supply control valve, the spray bar being further configured to alternately spray wash solution and blowing fluid by being alternately connected to the wash solution tank and the blowing fluid supply system, and the control device being configured to control the supply control valves to control the supply of wash solution and blowing fluid to the spray bar.

11- The washing machine according to claim 10, wherein:
the heat pump further comprises an air condenser arranged on the heat transfer fluid circulation loop, between the condenser and the evaporator and upstream of an expansion valve of the heat transfer fluid circulation loop, and a second fan configured to draw in from at least one from among air exiting the evaporator and air coming from an immediate environment of the washing machine and to circulate the drawn air in contact with the air condenser.

12- A method for operating a washing machine according to claim 11, wherein that the method comprises the steps consisting of:
a) operating the pump to circulate wash solution in the heating pipe, operating the first fan of the heat pump at a first speed to draw air from an immediate environment of the washing machine and circulate the air into contact with the evaporator, measuring a temperature of the wash solution using a temperature sensor in the wash solution tank, and operating the heat pump to heat the wash solution to a first target temperature, in such a manner as to start-up the washing machine;
b) operating the pump to supply the spray bar with wash solution and to circulate wash solution through the heating pipe, operating the heat pump to heat the wash solution, operating the first fan at a second speed, less than or equal to the first speed, to draw air from the immediate environment of the washing machine and circulate the air into contact with the evaporator, and operating the second fan to draw both air exiting the evaporator and air coming from the immediate environment of the washing machine and circulate the air into contact with the air condenser;
c) operating the pump to circulate wash solution in the heating pipe, stopping the supply of wash solution to the spray bar, operating the blowing fluid supply system to supply blowing fluid to the spray bar, operating the heat pump to heat the wash solution, operating the first fan at a second speed to draw air from the wash chamber and circulate the air into contact with the evaporator, and operating the second fan to draw both air exiting from the evaporator and air coming from the immediate environment of the washing machine and circulate said air into contact with the air condenser;
d) measuring the temperature of the wash solution using the temperature sensor in the wash solution tank; and
e) if the wash solution temperature is greater than a second target temperature, increase an operating speed of the second fan, the second target temperature being greater than or equal to the first target temperature.

13- An industrial production line, wherein the industrial production line comprises at least one washing machine according to claim 1 configured to sequentially receive, with washing cycles of less than 5 minutes, a plurality of parts to be washed.
